(19) United States
(12) Patent Application Publication
(10) Pub. No.: US 2024/0065296 A1
(43) Pub. Date: Feb. 29, 2024

(54) THE HOTDOG DOG BONE

(71) Applicants: Rahul Anand, Fairfield, CT (US); Isla Kaur Anand, Fairfield, CT (US); Rhiya Sohal Anand, Fairfield, CT (US); Kieran Singh Anand, Fairfield, CT (US)

(72) Inventors: Rahul Anand, Fairfield, CT (US); Isla Kaur Anand, Fairfield, CT (US); Rhiya Sohal Anand, Fairfield, CT (US); Kieran Singh Anand, Fairfield, CT (US)

(21) Appl. No.: 17/899,567

(22) Filed: Aug. 30, 2022

(51) Int. Cl. A23K 40/00; A23K 10/26; A23K 10/30; A23K 50/40

(52) U.S. Cl. CPC A23K 40/00; A23K 10/26; A23K 10/30; A23K 50/40

(57) ABSTRACT

A hot dog bone pet treat for providing nutrition for a dog is presented. The pet treat has a top, a bottom, a filling, a bun and one or more toppings. The filling may include one or more ingredients such as wheat flour, corn syrup, glycerin, gelatin, wheat protein lecithin, rosemary extract, potato flour and vegetable glycerin. Toppings are placed upon the top of the pet treat. The toppings include at least one of meat, cheese powder, potato, sweet potato, oatmeal. The meat is preferably bacon, beef, salmon, chicken, etc. The pet treats are highly palatable to pets and therefore very well-suited to delivery of health ingredients.

### FIELD OF THE INVENTION

This invention relates to treats for pets. More particularly, it relates to nutritional pet treats for dogs.

### BACKGROUND

Dogs were the first species to be domesticated, by hunter gatherers over 15,000 years ago, before the development of agriculture. The keeping of dogs as companion, particularly by elites, has a long history. The pet dog population has grown significantly after World War II as suburbanization has increased.

Dog treats serve different purposes. Puppies, for instance, need treats they can chew on when they are teething because their gums and jaws become very sore, and chewing provides relief Chewing on different treats allows the dog to receive nutrition during times between feedings.

Humans have been feeding treats to their pets for many years. The treats may be provided as a reward to a pet to promote desirable behaviors. Pet treats are typically rapidly consumed by the pets. Accordingly, treats have been viewed purely as a reward and are generally not considered to confer benefits on the consuming pet.

In light of the foregoing, it would be desirable to devise an improved dog treat that would combine people-like food shapes, such as a hot dog on a bun, with nutritious ingredients and various toppings. It would be further advantageous if the treat had a desirable crude protein, crude fat, calorie level, moisture content and fiber contents.

### BRIEF DESCRIPTION OF THE DRAWINGS

FIG. 1 is an illustrated view of a hotdog bone pet treat.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiment as illustrated in the drawing. While embodiments are described in connection with the drawing and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

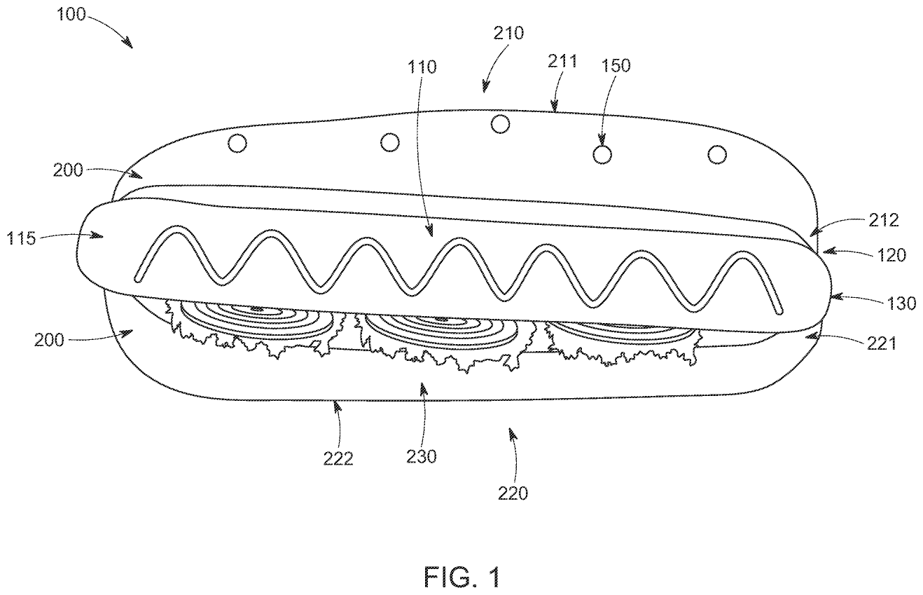

Referring to FIG. 1, an illustrated view of a hot dog bone pet treat 100 for providing a nutritious treat for a dog is presented. The pet treat 100 is useful for providing nutritional value in a snack or treat for a pet, such as a dog. Also, the hot dog bone pet treat 100 is cost effective, easy to use and efficient in the making of the treat.

The hot dog bone pet treat 100 has a bone 110. The bone 110 of the hot dog bone pet treat 100 is preferably cylindrical in shape, however other shapes are hereby contemplated, including, but not limited to, round, square, oval, oblong, etc. The bone 110 of the hot dog bone pet treat 100 has a top 120, a bottom 130, a center area 140 and one or more toppings 150. Although only one of the one or more toppings are shown, it would be obvious to one skilled in the art to use one or more other toppings 150.

The bone 110 of the hot dog bone pet treat 100 having a filling 115. The filling 115 is preferably made of at least one or more ingredients, such as, a wheat flour, a corn syrup, wheat gluten, lecithin, rosemary extract, potato flour, vegetable glycerin, a gelatin, a starch, a glycerin, a cellulose, etc. Once filling 115 is prepared, the bone 110 is shaped to the desired and predetermined shape, the filling 115 is then baked to make the bone 110.

The hot dog bone treat 100 further has a bun 200. The bun 200 has a top portion 210 and a bottom portion 220. The top portion 210 has a top 211 and a bottom 212. The bottom portion 220 has a top 221 and a bottom 222.

The bun 200 is made of a second filling 230. The second filling 230 is made of one or more second ingredients. The second ingredients are preferably made of peanut butter, however other ingredients are hereby contemplated, including, but not limited to, pumpkin, combination of peanut butter and pumpkin, etc.

Once the bun 200 is formed of the second filling 230, the bun 200 is separated to create the top portion 210 and the bottom portion 220 of the bun 200. The bottom 212 of the top portion 210 is coupled to the top 120 of the bone 110. The top 221 of the bottom portion 220 is coupled to the bottom 130 of the bone.

The bun 200 of the hot dog bone pet treat 100 is preferably cylindrical in shape, however other shapes are hereby contemplated, including, but not limited to, tubular, oblong, etc. The shape of the bun 200 is preferably the same shape as the bone 110, however it is hereby contemplated that the shape of the bun 200 and the bone 110 are not the same shape.

The toppings 150 are then placed onto the top 211 of the top portion 212 of the bun 110 of the hot dog bone pet treat 100. The one or more toppings 150 are at least one of the following: meat, cheese powder, potato, sweet potato, oatmeal, etc. The toppings 150 preferably in a flake format. The toppings 150 are pseudo-randomly placed onto the top 120 of the bone 110 of the hot dog bone pet treat 100. The meat is preferably one or more of: bacon, chicken, beef, salmon, etc.

The hot dog bone pet treat 100 preferably has a crude protein in a range between one percent (1%) and twenty-four percent (24%). The hot dog bone pet treat 100 preferably has a crude fat in a range between one-half of one percent (0.5%) and thirteen percent (13%). The hot dog bone pet treat 100 preferably has a calorie in a range between thirty-one (31) calories per treat and two hundred eighty-one (281) calories per treat. The hot dog bone pet treat 100 preferably has a moisture content in a range between eight percent (8%) and thirty percent (30%). The hot dog bone pet treat 100 preferably has a fiber content in a range between three percent (3%) and four and one-half percent (4.5%).

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A hot dog bone pet treat for providing a nutritious snack for a dog, the pet treat comprising:
a bone, the bone having a top, a bottom, one or more toppings and a filling;
the filling being made of one or more ingredients, wherein when the ingredients are combined, the filling is baked to create the bone;
a bun, the bun comprising:
the bun having a top portion and a bottom portion, wherein the top portion having a top and a bottom, wherein the bottom portion having a top and a bottom;
a second filling, the second filling being made of one or more second ingredients, wherein the filling is prepared and baked to create the bun, wherein after being baked, the bun is divided into the top portion and the bottom portion;
the bottom of the top portion of the bun being coupled to the top of the bone;
the top of the bottom portion of the bun being coupled to the bottom of the bone; and
wherein the one or more toppings are placed upon the top of the top portion of the bun of the pet treat.

2. The pet treat of claim 1, the one or more toppings being at least one of: a meat, potato, sweet potato and oatmeal.

3. The pet treat of claim 2, wherein the meat is bacon.

4. The pet treat of claim 2, wherein the meat is salmon.

5. The pet treat of claim 2, wherein the meat is beef.

6. The pet treat of claim 2, wherein the bone has a cylindrical shape.

7. The pet treat of claim 1, wherein the ingredients being one or more of: wheat flour, corn syrup, glycerin, gelatin, wheat protein lecithin, rosemary extract, potato flour and vegetable glycerin.

8. The pet treat of claim 1, wherein the pet treat has a crude protein in a range of one percent and twenty-four percent.

9. The pet treat of claim 1, wherein the pet treat has a crude fat in a range of one-half percent and thirteen percent.

10. The pet treat of claim 1, wherein the pet treat has a crude protein in a range of one percent and twenty-four percent.

11. The pet treat of claim 1, wherein the pet treat has a calorie per pet treat in a range of thirty-one calories and two-hundred eighty-one calories.

12. The pet treat of claim 1, wherein the pet treat has a moisture content in a range of eight percent and thirty percent.

13. The pet treat of claim 1, wherein the pet treat has a fiber content in a range of three percent and four and one-half percent.

14. The pet treat of claim 1, wherein the second ingredients are one or more of: peanut butter and pumpkin.

15. The pet treat of claim 1, wherein the bun has a cylindrical shape.

16. The pet treat of claim 1, wherein the bone and the bun have the same shape.
